(19) United States
(12) Patent Application Publication
(10) Pub. No.: US 2009/0235824 A1
(43) Pub. Date: Sep. 24, 2009

(54) Filtering Device To Filter The Air Taken In By A Cleaning Apparatus

(75) Inventor: Villelmo Bartolini, Foligno (IT)

Correspondence Address: MANNAVA & KANG, P.C., 11240 WAPLES MILL ROAD, Suite 300, FAIRFAX, VA, 22030, US

(73) Assignee: UNITEKNO SPA, Locallta Paclana, Foligno (IT)

(21) Appl. No.: 12/306,203

(22) PCT Filed: Jun. 23, 2006
(86) PCT No.: PCT/IT2006/000482

§ 371 Date: Dec. 22, 2008

(51) Int. Cl. B01D 47/02

(52) U.S. Cl. 96/300

(57) ABSTRACT

Filtering device for filtering the air taken in by a cleaning apparatus, comprising a container provided with a plurality of walls. The walls define at least a first containing compartment, able to contain a first filtering element and in which the air to be filtered is able to be introduced through an inlet pipe, and a second containing compartment, able to contain a second filtering element and connected to the first containing compartment by means of an intermediate pipe, and from which the filtered air is able to exit through a discharge pipe. The two containing compartments are disposed on inside the other, so that the innermost containing compartment is at least partly surrounded by the filtering element contained in the outermost containing compartment.

### FIELD OF THE INVENTION

The present invention concerns a filtering device to filter the air taken in by a cleaning apparatus by means of filtering elements, for example of the liquid bath type, or dry. To be more exact, the filtering elements are disposed in relative containing compartments, communicating with each other, and allow to retain the dirt, for example present in the air taken in, so as to separate the dirt from the air.

### BACKGROUND OF THE INVENTION

Filtering devices are known, for example of the liquid 15 bath type, normally water, which are used in cleaning apparatuses, such as vacuum cleaners, or the so-called vacuum cleaners for liquid.

A filtering device is known comprising a container which defines a containing compartment containing the water, and which is provided with an inlet pipe for the air to be filtered and a discharge pipe for the filtered air. Intake members are provided, which generate an intake flow from the inlet pipe to the discharge pipe in order to put droplets of nebulized water into suspension, with which the dirt mixes.

The discharge pipe is provided with filters, for example of the spongy type, able to block the droplets of water.

However, this known filtering device has the disadvantage that it has a relatively low filtering capacity.

A filtering device is also known, whose container is provided with two containing compartments disposed one above the other and communicating with each other.

In this known solution, the intake members generate an intake flow from the inlet pipe to the discharge pipe through the two containing compartments in order to effect a progressive double filtering, thus obtaining a relatively high filtering capacity. However, the known double filtering device, although it offers a greater filtering capacity compared with known devices with a single containing compartment, is very complex and bulky.

In fact, the known double filtering device occupies a 10 relatively large space, especially in relation to the size of the cleaning apparatus in which it is normally used.

A purpose of the present invention is therefore to achieve a filtering device which is compact, which has a limited bulk with respect to known devices and which has a high filtering capacity.

The Applicant has devised, tested and embodied the present invention to overcome the shortcomings of the state of the art and to obtain these and other purposes and advantages.

### SUMMARY OF THE INVENTION

The present invention is set forth and characterized in the main claim, while the dependent claims describe other characteristics of the invention or variants to the main inventive idea.

A filtering device according to the present invention is able to be used to filter the air taken in by a cleaning apparatus, such as for example a vacuum cleaner, a vacuum cleaner for liquids, or similar apparatus.

In accordance with the above purpose, the device 30 according to the present invention comprises a container, provided with a plurality of walls which define at least a first containing compartment, able to contain a first filtering element, and a second containing compartment, able to contain a second filtering element. Advantageously, at least one of the two filtering elements is of the liquid bath type, or dry.

According to a variant of the invention, at least one of 5 the two filtering elements comprises a gas, for example air.

The air to be filtered is able to be introduced into the first containing compartment through an inlet pipe.

In the second containing compartment, connected to the 10 first containing compartment by means of an intermediate pipe, the filtered air is able to exit through a discharge pipe.

According to a characteristic of the present invention, the two containing compartments are disposed one inside the other, and the innermost compartment is at least partly surrounded by the filtering element contained in the outermost compartment.

The filtering device according to the present invention allows to perform a progressive double filtering in a single container, therefore guaranteeing a high filtering capacity, while it is compact and has a limited bulk compared with known devices.

Advantageously, the filtering capacity of the device according to the present invention can be selectively varied, for example according to the material to be taken in, which can be dry, liquid or other, by varying the type of filtering element contained in each compartment.

According to one embodiment of the present invention, the two containing compartments are substantially co-planar with each other and, for example, substantially co-axial with each other.

The walls comprise an inner wall, an intermediate wall common to both the containing compartments, and an outer wall.

To be more exact, the inner wall and the intermediate wall define the innermost compartment, while the intermediate wall and the outer wall define the outermost compartment.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a three-dimensional view, partly sectioned, of a filtering device according to the present invention;

FIG. 2 is a section of the filtering device from II to 15 II of FIG. 1;

FIG. 3 is a section of the filtering device from III to III in FIG. 1;

FIG. 4 is a section of the filtering device from IV to IV in FIG. 1;

FIG. 5 is a section of the filtering device from V to V in FIG. 2.

### DETAILED DESCRIPTION OF A PREFERENTIAL FORM OF EMBODIMENT

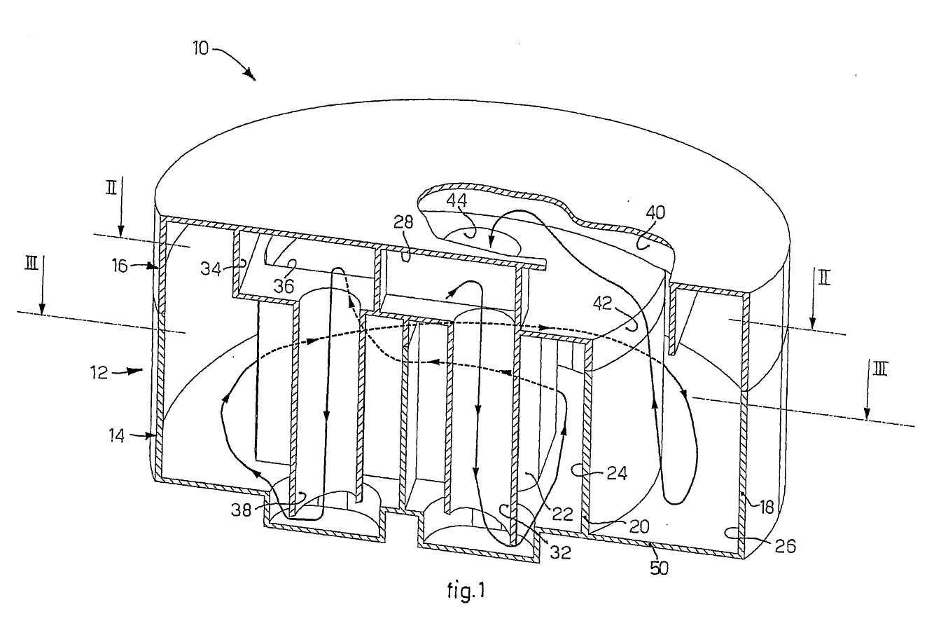

With reference to FIG. 1, a filtering device 10 according to the present invention can be used to filter, in a liquid bath, the air taken in by a cleaning apparatus.

The filtering device 10 comprises a container 12, provided with a lower part 14, which functions as a base, and an upper part 16, which functions as a lid.

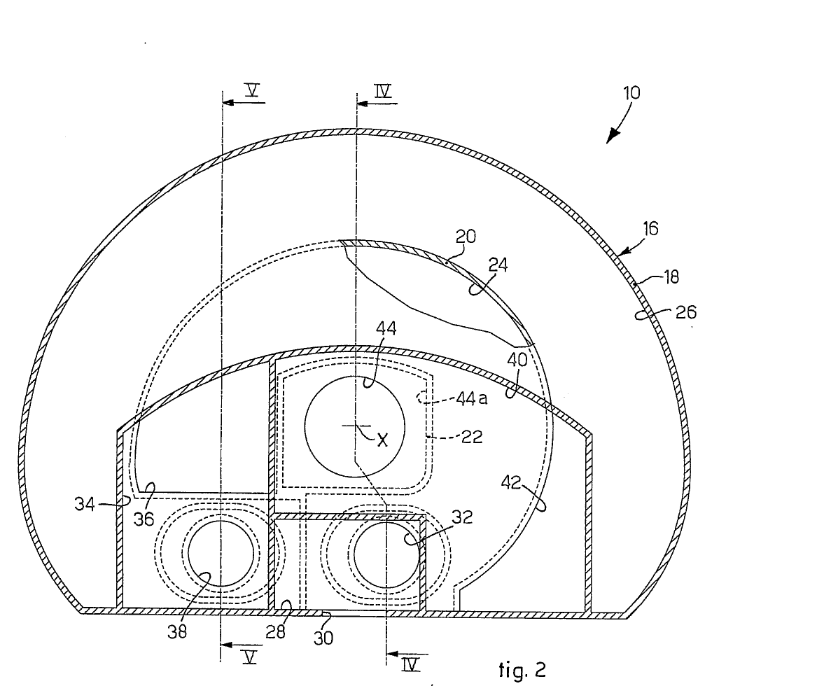

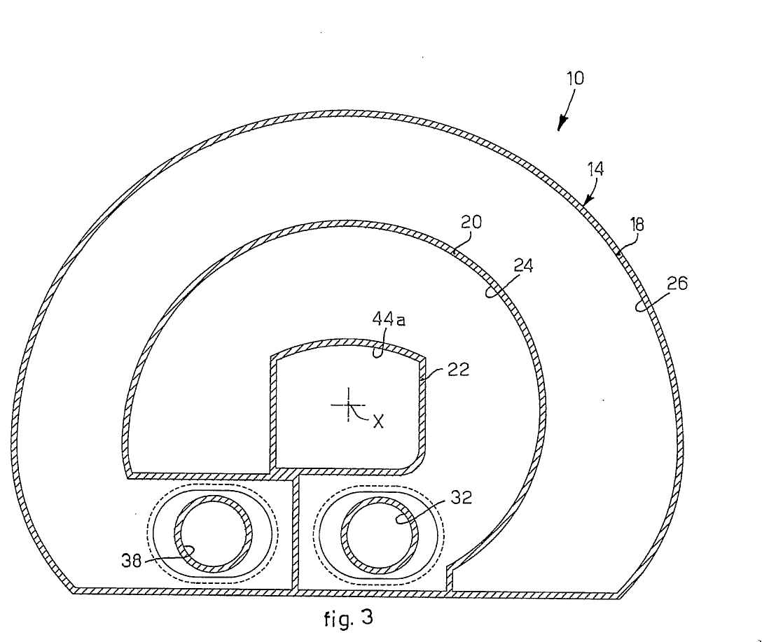

The container 12 (FIGS. 1 to 5) comprises an outer wall 30 18, an intermediate wall 20 and an inner wall 22, walls which have a substantially arched shape, and are substantially parallel and coaxial with each other with respect to an axis X (FIGS. 2, 3 and 4).

The inner wall 22 and the intermediate wall 20 define a first containing compartment 24, having a partly annular shape.

The intermediate wall 20 and the outer wall 18 define a 5 second containing compartment 26, outside with respect to the first compartment 24 and disposed adjacent and coaxial with the first containing compartment 24 with respect to the axis X.

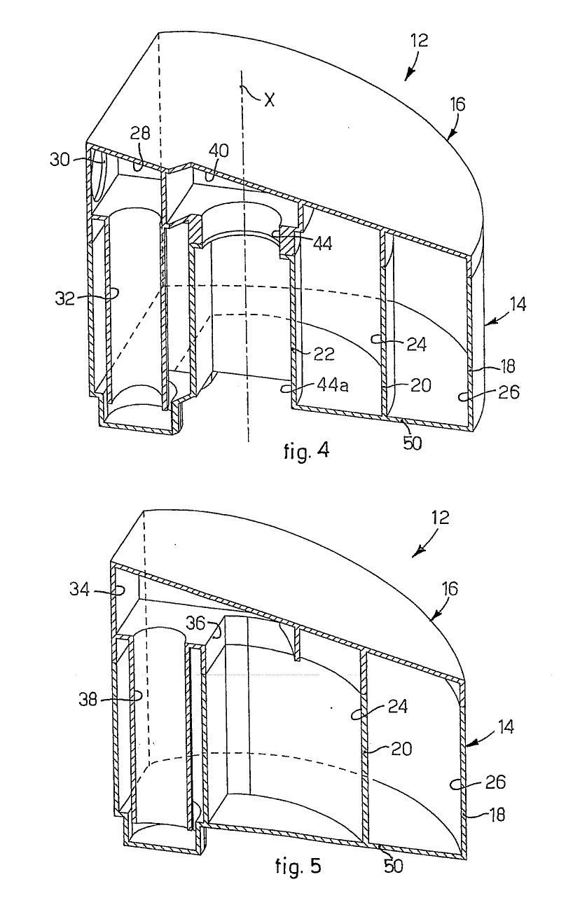

The two containing compartments 24 and 26 are therefore 10 separated from each other by the intermediate wall 20 and are substantially co-planar to each other, that is, the two containing compartments 24 and 26 extend coaxially starting from a common bottom surface 50 of the container 12 (FIGS. 4 and 5).

The device 10 also comprises an inlet chamber 28, which is made above the first containing compartment 24, and on one wall of which (FIGS. 2 and 4) an inlet hole 30 is made for the air to be filtered.

The inlet chamber 28 also communicates with an inlet pipe 20 32, which has a substantially tubular shape and has one lower end partly immersed in the water contained in the first containing compartment 24.

Between the first containing compartment 24 and the second containing compartment 26 the device 10 comprises a transit chamber 34, which is made above the two containing compartments 24 and 26.

The transit chamber 34 communicates on one side with the first containing compartment 24 through a first aperture 36, made above the level of the water, and on the other side with the upper end of an intermediate pipe 38.

The intermediate pipe 38 is substantially tubular and has one lower end partly immersed in the water contained in the second containing compartment 26. Between the second containing compartment 26 and the discharge pipe 18, the device 10 also comprises a discharge chamber 40, which is made above the first containing compartment 24 and is separated therefrom.

The discharge chamber 40 communicates on one side with the second containing compartment 26 through a second aperture 42, made above the level of the water, and on the other side with the upper end of a discharge pipe 44.

Downstream of the second containing compartment 26 an 10 intake unit is provided, of a substantially known type and not shown here, connected to the lower end 44a (FIGS. 2, 3 and 4) of the discharge pipe 44.

The intake unit generates an intake flow from the inlet pipe 32 to the discharge pipe 44.

We shall now describe the functioning of the filtering device 10 according to the present invention.

The air, which is taken from the inlet hole 30, passes through the inlet chamber 28 and the inlet pipe 32, to mix with the water present in the first containing compartment 24, so that the dirt contained therein is deposited on the bottom of the first compartment 24.

After passing through the first containing compartment 26, the air transits through the first aperture 36, to pass into the transit chamber 34. From here, the air passes inside the intermediate pipe 38 to mix with the water of the second containing compartment 26.

In the second compartment 26 the dirt, still present in the already partly filtered air, is deposited in the water contained therein, while the completely clean air passes through the second containing compartment 26 and transits through the second aperture 42 to pass into the discharge chamber 40. From here, the filtered air is introduced into the discharge pipe 44, where filters are disposed, for example of the spongy type, able to block the water.

It is clear that modifications and/or additions of parts may be made to the filtering device 10 as described heretofore, without departing from the field and scope of the present invention.

It is also clear that, although the present invention has been described with reference to specific examples, a person of skill in the art shall certainly be able to achieve many other equivalent forms of filtering device for filtering the air taken in by a cleaning apparatus, having the characteristics as set forth in the claims and hence all coming within the field of protection defined thereby.

1. A filtering device for filtering the air taken in by a cleaning apparatus, comprising a container provided with a plurality of walls which define at least:
a first containing compartment, able to contain a first filtering element and into which the air to be filtered is able to be introduced through an inlet pipe; and
a second containing compartment, able to contain a second filtering element and connected to said first containing compartment by means of an intermediate pipe, and from which the filtered air is able to exit through a discharge pipe,
wherein said first and second containing compartments comprise respectively an innermost containing compartment and an outermost containing compartment which are separated one with respect to the other and are disposed one inside the other, wherein said innermost containing compartment is at least partly surrounded by the filtering element contained in said outermost containing compartment, wherein said walls have a substantially arched shape and comprise an inner wall and an intermediate wall which define said innermost containing compartment, whereby said innermost containing compartment has a partly annular shape, wherein said walls further comprise an intermediate wall and an outer wall which define said outermost containing compartment, which is outside with respect to said innermost containing compartment and is disposed adjacent and coaxial with said innermost containing compartment with respect to an axis (X), wherein an inlet chamber is made above said innermost containing compartment, wherein on one wall of said inlet chamber an inlet hole is made for the air to be filtered, and wherein said inlet chamber also communicates with said inlet pipe, which has a substantially tubular shape and has one lower end partly immersed in the water contained in said innermost containing compartment.

2. The filtering device as in claim 1, wherein said first and second containing compartments are substantially co-planar with each other.

3-8. (canceled)

9. The filtering device as in claim 1, wherein at least one of said first filtering element and second filtering element is of the dry type.

10. The filtering device as in claim 1, further comprising a transit chamber able to put said first and second containing compartments into communication.

11. The filtering device as in claim 10, wherein said transit chamber is in communication with said first containing compartment through an aperture, made above said first filtering element.

12. The filtering device as in claim 11, wherein said transit chamber is in communication with said second containing compartment through an intermediate pipe.

13. (canceled)

14. The filtering device as in claim 12, wherein said intermediate pipe has a substantially tubular shape and has a lower end cooperating with said second filtering element.

15. The filtering device as in claim 1, wherein at least one of said first filtering element and second filtering element is of the liquid bath type.
